(19) United States
(12) Patent Application Publication
(10) Pub. No.: US 2024/0049317 A1
(43) Pub. Date: Feb. 8, 2024

(54) ELECTRONIC DEVICE, METHOD, AND NON-TRANSITORY COMPUTER READABLE STORAGE MEDIUM FOR AUDIO STREAMING IN WIRELESS ENVIRONMENT

(71) Applicant: SAMSUNG ELECTRONICS CO., LTD., Suwon-si (KR)

(72) Inventors: Youngsin MOON, Suwon-si (KR); Gupil CHEONG, Suwon-si (KR); Doosuk KANG, Suwon-si (KR); Kyusang RYU, Suwon-si (KR); Wonkyoung JANG, Suwon-si (KR); Sungjun CHOI, Suwon-si (KR)

(73) Assignee: SAMSUNG ELECTRONICS CO., LTD., Suwon-si (KR)

(21) Appl. No.: 18/205,880

(22) Filed: Jun. 5, 2023

Related U.S. Application Data
(63) Continuation of application No. PCT/KR2023/006078, filed on May 3, 2023.

(30) Foreign Application Priority Data
Aug. 4, 2022 (KR) 10-2022-0097170

(51) Int. Cl. H04W 76/15; H04W 76/20

(52) U.S. Cl. CPC H04W 76/15; H04W 76/20

(57) ABSTRACT

An electronic device includes: a wireless communication module; and a processor, coupled with the wireless communication module, to: establish a first link with a first external device and establish a second link with a second external device; receive an input initiating audio streaming through the first link and through the second link; identify, in response to the input, a label indicating information for codec configuration and information for quality of service configuration; transmit a signal through the first link to the first external device and through the second link to the second external device, the signal being indicating the identified label; and switch from a first state of the electronic device to a second state of the electronic device, based on the signal transmitted to the first external device and to the second external device.

### CROSS-REFERENCE TO RELATED APPLICATION

This application is a continuation of PCT International Application No. PCT/KR2023/006078, which was filed on May 3, 2023, and claims priority to Korean Patent Application No. 10-2022-0097170, filed on Aug. 4, 2022, in the Korean Intellectual Property Office, the disclosure of which are incorporated by reference herein their entirety.

### BACKGROUND

### 1. Field

The disclosure relates to an electronic device, a method, and a non-transitory computer readable storage medium for an audio streaming in a wireless environment.

### 2. Description of Related Art

Compared to legacy Bluetooth (or classic Bluetooth), Bluetooth low energy (BLE) may provide reduced power consumption and at least a similar or often greater communication range between connected devices. BLE may be provided on an industrial, scientific, and medical (ISM) radio band.

### SUMMARY

An electronic device operating as a central device in a wireless environment is provided. The electronic device may include a communication circuit for Bluetooth low energy (BLE).

The electronic device may include a processor operably coupled with the communication circuit. The processor may be configured to establish, through the communication circuit, a first communication link with a first external electronic device operating as a first peripheral device and a second communication link with a second external electronic device operating as a second peripheral device. The processor may be configured to receive an input indicating to initiate audio streaming through the first communication link and the second communication link. The processor may be configured to identify a label indicating information for codec configuration of the audio streaming and information for quality of server (QoS) configuration of the audio streaming, in response to the input. The processor may be configured to transmit a signal indicating the identified label through the first communication link to the first external electronic device and transmit the signal through the second communication link to the second external electronic device. The processor may be configured to switch a state of the electronic device for the audio streaming from an idle state to an enabling state, based on the transmission of the signal to the first external electronic device and the transmission of the signal to the second external electronic device.

A method executed in an electronic device operating as a central device in a wireless environment is provided. The method may include establishing, through the communication circuit, a first communication link with a first external electronic device operating as a first peripheral device and a second communication link with a second external electronic device operating as a second peripheral device. The method may include receive an input indicating to initiate audio streaming through the first communication link and the second communication link. The method may include identifying a label indicating information for codec configuration of the audio streaming and information for quality of service (QoS) configuration of the audio streaming, in response to the input. The method may include transmitting a signal indicating the identified label through the first communication link to the first external electronic device and transmitting the signal through the second communication link to the second external electronic device. The method may include switching a state of the electronic device for the audio streaming from an idle state to an enabling state, based on the transmission of the signal to the first external electronic device and the transmission of the signal to the second external electronic device.

A non-transitory computer-readable storage medium storing one or more programs is provided. The one or more programs may include instructions which, when executed by a processor of an electronic device operating as a central device in a wireless environment and including a communication circuit for the Bluetooth Low Energy (BLE), cause the electronic device to establish, through the communication circuit, a first communication link with a first external electronic device operating as a first peripheral device and a second communication link with a second external electronic device operating as a second peripheral device. The one or more programs may include instructions which, when executed by the processor, cause the electronic device to receive an input indicating to initiate audio streaming through the first communication link and the second communication link. The one or more programs may include instructions which, when executed by the processor, cause the electronic device to identify a label indicating information for codec configuration of the audio streaming and information for quality of server (QoS) configuration of the audio streaming, in response to the input. The one or more programs may include instructions which, when executed by the processor, cause the electronic device to transmit a signal indicating the identified label through the first communication link to the first external electronic device and transmit the signal through the second communication link to the second external electronic device. The one or more programs may include instructions which, when executed by the processor, cause the electronic device to switch a state of the electronic device for the audio streaming from an idle state to an enabling state, based on the transmission of the signal to the first external electronic device and the transmission of the signal to the second external electronic device.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to various embodiments.

FIG. 2 illustrates an example of a wireless environment including an electronic device.

FIG. 3 is a flowchart illustrating a method of generating a connected isochronous group (CIG) event including connected isochronous stream (CIS) events for audio streaming.

FIG. 4 is a flowchart illustrating an exemplary method of transmitting a signal indicating a label for audio streaming.

FIG. 5 illustrates an example of an input indicating that audio streaming is initiated.

FIG. 6 illustrates an example of a direct switching from an idle state to an enabling state.

FIG. 7 is a flowchart illustrating an exemplary method of identifying a label corresponding to a type of service.

FIG. 8 is a flowchart illustrating an exemplary method of obtaining a plurality of labels.

FIG. 9 illustrates an exemplary method of transmitting a signal indicating a label for another audio streaming in response to a request from another audio streaming identified while the service of audio streaming is provided.

FIG. 10 is a flowchart illustrating an exemplary method of transmitting a message for generating a CIG event including CIS events.

### DETAILED DESCRIPTION

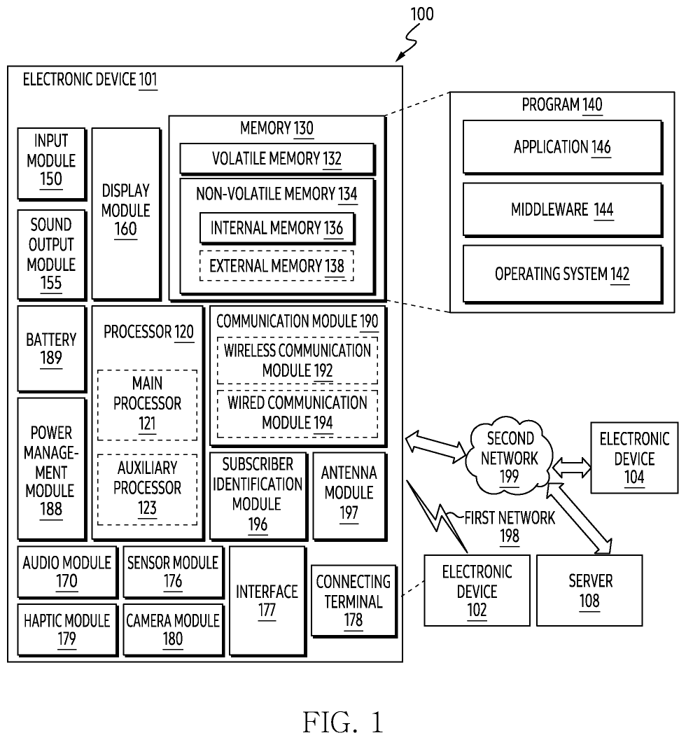

FIG. 1 is a block diagram illustrating an electronic device 101 in a network environment 100 according to various embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thererto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

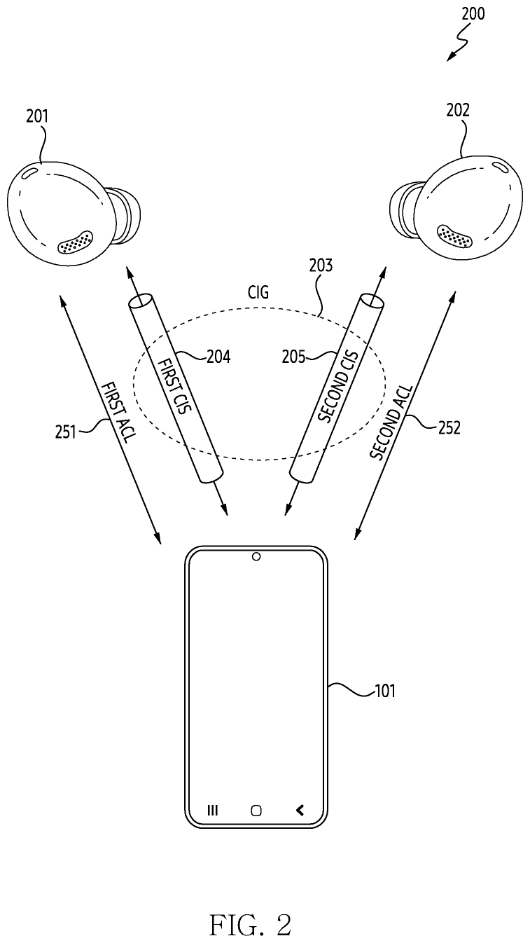

FIG. 2 illustrates an example of a wireless environment including an electronic device.

Referring to FIG. 2, the wireless environment 200 may include an electronic device 101, a first external electronic device 201, and a second external electronic device 202.

The electronic device 101 in wireless environment 200 may be an audio source device such as a smartphone, a laptop computer, a desktop computer, or a tablet PC. For example, the electronic device 101 may transmit data on audio being played in the electronic device 101 to each of the first external electronic device 201 and the second external electronic device 202. For example, the data may be usable within each of the first external electronic device 201 and the second external electronic device 202 to output the audio from each of the first external electronic device 201 and the second external electronic device 202. In an embodiment, the electronic device 101 may be referred to as an audio streaming endpoint (ASE), a client device, a central device, a primary device, or a main device.

The first external electronic device 201 and the second external electronic device 202 in the wireless environment 200 may be audio sink devices such as earbuds or earphones. For example, the first external electronic device 201 and the second external electronic device 202 may be configured as a pair. However, it is not limited thereto. For example, each of the first external electronic device 201 and the second external electronic device 202 may receive data on audio from the electronic device 101, and output the audio through speakers of each of the first external electronic device 201 and the second external electronic device 202 based on the data. For example, the first external electronic device 201 and the second external electronic device 202 may respectively receive requests from the electronic device 101, and respectively transmit data on audio respectively obtained through a microphone of the first external electronic device 201 and a microphone of the second external electronic device 202 to the electronic device 101, in response to the request. For example, the data may be usable to reproduce the audio in the electronic device 101. In an embodiment, each of the first external electronic device 201 and the second external electronic device 202 may be referred to as a sink ASE, a server device, a peripheral device, a secondary device, or a sub device.

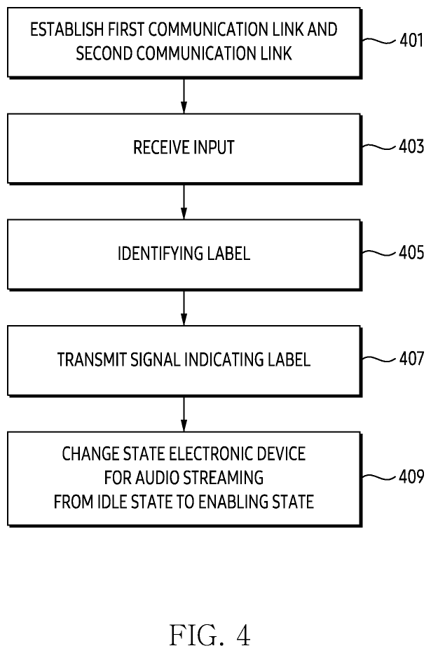

The electronic device 101 may establish a first asynchronous connection-less (ACL) connection 251 with the first external electronic device 201. For example, the first ACL connection 251 may be used to control ASE caused between the electronic device 101 and the first external electronic device 201. For example, the first ACL connection 251 may be used for operations to be illustrated through the description of FIG. 4.

The electronic device 101 may establish a second ACL connection 252 with the second external electronic device 202. For example, the second ACL connection 252 may be used to control ASE caused between the electronic device 101 and the second external electronic device 202.

The electronic device 101, the first external electronic device 201, and the second external electronic device 202 may support multi-stream audio. For example, synchronized, independent, multiple audio streams may be transmitted between the electronic device 101 and the first external electronic device 201 and/or between the electronic device 101 and the second external electronic device 202. For example, a connected isochronous group (CIG) 203 including connected isochronous streams (CIS) (e.g., a first CIS 204 and a second CIS 205) may be used to support the multi-stream audio.

For example, the CIG 203 may consist of two or more CISs having the same isochronous (ISO) interval. For example, the CIG 203 may include a first CIS 204 and a second CIS 205. For example, each of the first CIS 204 and the second CIS 205 may be a logical transport between the electronic device 101 and the first external electronic device 201, and between the electronic device 101 and the second external electronic device 202 to uni-directionally or bi-directionally transfer isochronous data. For example, each of the first CIS 204 and the second CIS 205 may be related to an ACL (asynchronous connection). For example, each of the first CIS 204 and the second CIS 205 may support packets of variable size and may support transmitting one or more packets in an isochronous event.

For example, the first CIS 204 may be used to transmit at least one packet from the electronic device 101 to the first external electronic device 201. For example, the at least one packet may be used to output audio being played in the electronic device 101 through a speaker of the first external electronic device 201. For example, the first CIS 204 may be used to transmit an acknowledgement signal for at least one packet or a non-acknowledgement signal for at least one packet from the first external electronic device 201 to the electronic device 101. For example, the acknowledgement signal may be transmitted from the first external electronic device 201 to the electronic device 101 through the first CIS 204 to indicate that the first external electronic device 201 successfully receives the at least one packet, and the non-acknowledgement signal may be transmitted from the first external electronic device 201 to the electronic device 101 through the first CIS 204 to indicate that the first external electronic device 201 fails to receive the at least one packet.

For example, the second CIS 205 may be used to transmit at least one packet from the electronic device 101 to the second external electronic device 202. For example, the at least one packet may be used to output audio being played in the electronic device 101 through the speaker of the second external electronic device 202. For example, the audio output through the speaker of the first external electronic device 201 and the audio output through the speaker of the second external electronic device 202 may provide stereophonic sound. However, it is not limited thereto. For example, the second CIS 205 may be used to transmit an acknowledgement signal for the at least one packet or a non-acknowledgement signal for the at least one packet from the second external electronic device 202 to the electronic device 101.

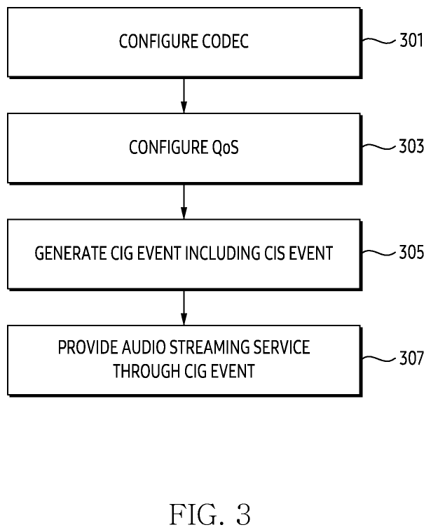

FIG. 3 is a flowchart illustrating a method of generating a connected isochronous group (CIG) event including connected isochronous stream (CIS) events for audio streaming.

Referring to FIG. 3, in operation 301, the central device may configure a codec in response to an audio streaming request. The central device may transmit a message indicating that the codec is configured to one or more peripheral devices. For example, the message may include data indicating the number of devices related to the audio streaming (e.g., the number of the central device and the one or more peripheral devices) (e.g., Number_of_ASEs), data indicating an identifier (e.g., ASE_ID[i]) of the central device, data indicating a target latency (e.g., Target_Latency[i]) of the audio streaming, data indicating a target transmission speed (e.g., Target_PHY[i]) for the target latency of the audio streaming, data indicating a codec identifier (e.g., Codec_ID[i]) of the audio streaming, data indicating a codec-specific configuration (e.g., Codec_Specific_Configuration), and data indicating the length of the codec-specific configuration (e.g., Codec_Specific_Configuration_Length[i]). The one or more peripheral devices may transmit a message indicating that the configuration of the codec is completed to the central device, based on the message and a response message indicating the reception of the message. The one or more peripheral devices may be in a codec configured state switched from the idle state by transmitting the message indicating that the configuration of the codec is completed. The central device may complete the configuration of the codec based on the reception of the response message and the message indicating that the configuration of the codec is completed. The central device may be in a codec configured state switched from an idle state by completing the configuration of the codec.

In operation 303, the central device in the codec configured state may configure quality of service (QoS). The central device may transmit to the one or more peripheral devices a message indicating that QoS is configured. For example, the message may include data indicating the number of devices related to the audio streaming (e.g., the number of the central device and the one or more peripheral devices) (e.g., Number_of_ASEs), data indicating an identifier (e.g., ASE_ID[i]) of the central device, data indicating an identifier (e.g/, CIG_ID[i]) of the CIG for the audio streaming, data indicating an identifier (e.g., CIS ID[i]) of the CIS for the audio streaming, data indicating a period for the audio streaming (e.g., service data unit (SDU) Interval[i]), data indicating whether the data packet for the audio streaming can be framed (eg, Framing[i]), data indicating max transport latency (e.g., Max_Transport_Latency [i]) of the audio streaming, data indicating a transmission speed (e.g., PHY[i]) for the max transport latency of the audio streaming, data indicating the maximum size (e.g., Max_SDU[i]) of the data packet for the audio streaming, data indicating the number of retransmissions of the data packet for the audio streaming (e.g., Retransmission Number[i]), and data indicating a presentation delay (e.g., Presentation Delay[i]) of the audio streaming. To the central device, the one or more peripheral devices may transmit a message indicating that the configuration of the QoS is completed based on the response message indicating the reception of the message and the message. The one or more the peripheral devices may be in the QoS configured state switched from the codec configured state by transmitting the message indicating that the of the QoS configuration is completed. The central device may complete the QoS configuration based on reception of the response message and the message indicating that the QoS configuration is completed. The central device may be in the QoS configured state switched from the codec configured state by completing the configuration of the QoS. Each of the central device and the one or more peripheral devices may switch the QoS configured state into an enabling state.

In operation 305, the central device in the enabling state may generate a CIG event including one or more CIS events for the one or more peripheral devices. The central device may transmit one or more messages indicating a request for one or more CIS events to the one or more peripheral devices. The one or more peripheral devices may receive the one or more messages from the central device. The one or more peripheral devices may switch the enabling state to a streaming state based at least in part on the reception of the one or more messages. The one or more peripheral devices may transmit a response message for the message to the central device. The central device may generate, establish, or obtain the CIG event including the one or more CIS events based on the response message received from the one or more peripheral devices. The central device may switch the enabling state into a streaming state based on at least a part of the generation of the response message or the CIG event.

In operation 307, the central device in the streaming state may provide the audio streaming service through the CIG event. For example, the central device may perform the audio streaming with each of the one or more peripheral devices by using each of the one or more CIS events.

A time for executing signaling between the central device and the one or more peripheral devices in operation 301 and operation 305 by the central device and the one or more peripheral devices may generally be about 1.5 seconds. A user using the service of the audio streaming may feel uncomfortable with respect to the execution time of the signaling.

The electronic device 101, the first external electronic device 201, and the second external electronic device 202 illustrated through the following descriptions may execute operations for reducing the execution time of the signaling. For example, the operations executed by the electronic device 101, the first external electronic device 201, and the second external electronic device 202 may include operations to reduce the time to execute operations 301 and 303. For example, the operations executed by the electronic device 101, the first external electronic device 201, and the second external electronic device 202 may include operations to reduce the time to execute operation 305.

The following descriptions illustrate an example in which the electronic device 101 provides audio streaming with two external electronic devices (e.g., the first external electronic device 201 and the second external electronic device 202), but this is for convenience of explanation. For example, the following descriptions can also be applied when the electronic device 101 provides audio streaming with a single external electronic device. For example, the following descriptions can also be applied when electronic device 101 provides audio streaming with three or more external electronic devices.

FIG. 4 is a flowchart illustrating an exemplary method of transmitting a signal indicating a label for audio streaming. This method may be executed by the electronic device 101 in FIG. 1, the electronic device 101 in FIG. 2, the first external electronic device 201 in FIG. 2, the second external electronic device 202 in FIG. 2, the processor 120 in FIG. 1, the processor 120 in FIG. 2, the processor of the first external electronic device 201 in FIG. 2, and/or the processor of the second external electronic device 202 in FIG. 2.

Referring to FIG. 4, in operation 401, the processor 120 of the electronic device 101 operating as a central device may establish a first communication link with the first external electronic device 201 operating as a first peripheral device and a second communication link with the second external electronic device 202 operating as a second peripheral device. For example, each of the first communication link and the second communication link may be established based at least partially on an advertising signal. For example, the first external electronic device 201 and/or the second external electronic device 202 may broadcast the advertising signal. In response to the reception of the advertising signal, the electronic device 101 may transmit a connection request signal to the first external electronic device 201 and/or the second external electronic device 202. For example, the electronic device 101 may establish the first communication link and the second communication link based at least partially on the connection request signal.

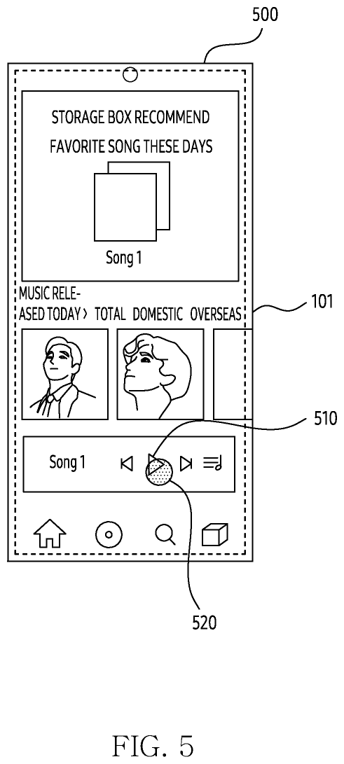

In operation 403, the processor 120 may receive an input indicating that an audio service is initiated through the first communication link and through the second communication link. For example, the input may include an input indicating that audio streaming is initiated. For example, the input may be received through the display of the electronic device 101 (e.g., the display module 160 in FIG. 1). For example, the input may be a user input received through the display and indicating that audio is played. The user input may be illustrated in FIG. 5.

FIG. 5 illustrates an example of an input indicating that audio streaming is initiated.

Referring to FIG. 5, the processor 120 may display a user interface 500 for reproducing audio through the display. For example, the user interface 500 may include an executable object 510 for playing music. For example, the processor 120 may receive a user input 520 on the executable object 510 as the input. FIG. 5 illustrates an example in which the input is a user input 520 on the executable object 510, but it is for convenience of description. The input may be variously defined in the electronic device 101. For example, the input may be a user input for displaying the user interface 500. For example, the user input may include user input on the executable object for executing a software application providing the user interface 500. For example, the input may include changing a state of the software application from a background state to a foreground state. However, it is not limited thereto.

The input indicating that the audio service is initiated is illustrated as being received through the display of the electronic device 101 (e.g., the display module 160 in FIG. 1), but is not limited thereto. For example, the input may include receiving a predetermined signal from an external electronic device. For example, the input may include receiving the predetermined signal from at least a part of the first external electronic device 201 and the second external electronic device 202. For example, the predetermined signal may be transmitted to the electronic device 101 in response to a user input caused for at least a part of the first external electronic device 201 and the second external electronic device 202. For example, the input may include the occurrence of a predetermined event caused within the electronic device 101. For example, the input may include a user's voice command through input module 150 (e.g., the microphone) of the electronic device 101.

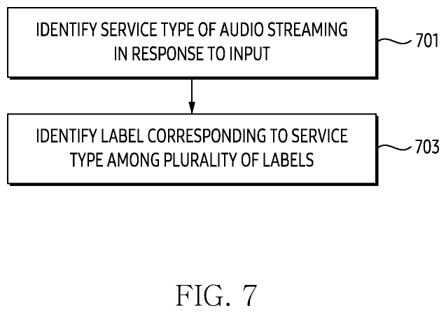

Referring back to FIG. 4, in operation 405, the processor 120 may identify a label indicating information for codec configuration of the audio streaming and/or information for QoS configuration of the audio streaming. For example, in order to simplify operations for the codec configuration with the first external electronic device 201 and the second external electronic device 202 and operations for the QoS configuration, the label may be defined in the electronic device 101, the first external electronic device 201, and the second external electronic device 202. For example, the label may indicate at least a portion of the data illustrated in operation 301 (e.g., the information for the codec configuration of the audio streaming) and at least a portion of the data illustrated in operation 303 (e.g., the information for the QoS configuration of the audio streaming). For example, the label may be defined to bypass a state of the electronic device 101 for the codec configuration, a state of the first external electronic device 201 for the codec configuration, a state of the second external electronic device 202 for the codec configuration, a state of the electronic device 101 for the above QoS configuration, a state for configuring the QoS of the first external electronic device 201, and a state for configuring the QoS of the second external electronic device 202. For example, the label may be obtained before the input is received. For example, the label may be stored in the electronic device 101, the first external electronic device 201, and the second external electronic device 202 before the input is received. For example, the label may be identified among a plurality of labels defined in the electronic device 101, the first external electronic device 201, and the second external electronic device 202. Identifying the label among the plurality of labels will be illustrated in FIG. 7.

For example, the information for the codec configuration may include data indicating a codec identifier of the audio streaming, data indicating a target latency of the audio streaming, and/or data indicating a target transmission speed for the target latency of the audio streaming. However, it is not limited thereto.

For example, the information for the QoS configuration may include data indicating a max transport latency of the audio streaming, data indicating a transmission speed for the max transport latency of the audio streaming, data indicating a period for the audio streaming, and/or data indicating whether data packets for the audio streaming can be framed. However, it is not limited thereto.

For example, the information indicated by the label may be represented as shown in Table 1 below.

TABLE 1

| State | Idle −> Enabling | |
|---|---|---|
| | Idle −> Codec Config | |
| Number_of_ASEs | 1 | |
| ASE_ID | 0x01 | |
| Target_Latency | Target high reliability | |
| Target_PHY | LE 2M PHY | |
| Codec_ID | LC3 | |
| Sampling Frequency | 48 | kHz |
| Frame Duration | 10 | ms |
| Audio Locations | Front Right | |
| Frame Size | 120 | byte |
| Number of Frame | 1 | |
| per SDU | | |
| | Codec Config −> QoS Config | |
| Number_of_ASEs | 1 | |
| ASE_ID | 0x01 | |
| CIG_ID | 0x01 | |
| CIS_ID | 0x00 | |
| SDU_Interval | 10 | ms |
| Framing | Unframed | |
| PHY | LE 2M PHY | |
| Max_SDU | 120 | byte |
| RIN | 13 | |
| MTL | 100 | ms |
| Pressentation | 40 | ms |
| delay | | |

| | |
|---|---|
| | QoS Config −> Enabling |
| Number_of_ASEs | 1 |
| ASE_ID | 0x01 |
| Metadata | Streaing Audio Contexts |
| Value | Media |

As shown in Table 1, the label may indicate a direct switching from an idle state (example through the description of FIG. 3) to an enabling state (example through the description of FIG. 3), information for switching the idle state to a codec configured state (e.g., the information for the codec configuration of the audio streaming) (example through the description of FIG. 3), information for switching the codec configured state to a QoS configured state (e.g., the information for the QOS configuration of the audio streaming) (example through the description of FIG. 3), and information for switching the QoS configured state to the enabling state.

The label can be simplified, as shown in Table 2 below. However, this is not limited.

TABLE 2

| State | Idle −> Enabling | |
|---|---|---|
| Number_of_ASEs | 1 | |
| ASE_ID | 0x01 | |
| Max_SDU | 120 | byte |
| Target_PHY | LE 2M PHY | |
| Codec_ID | LC3 | |
| Sampling Frequency | 48 | kHz |
| Frame Duration | 10 | ms |
| Audio Locations | Front Right | |
| Frame Size | 120 | byte |
| Framing | Unframed | |
| Value | Media | |
| MTL | 100 | ms |
| Pressentation delay | 40 | ms |

As shown in Table 2, the label may indicate a direct switching from an idle state to an enabling state, a part of the information for switching the idle state to the codec configured state (e.g., a part of the information for the codec configuration of the audio streaming), and a part of the information for switching the codec configured state to the QoS configured state (e.g., a part of the information for the QoS configuration of the audio streaming).

For example, the format of the label may vary. For example, the label may indicate the information for the codec configuration of the audio streaming and the information for the QoS configuration of the audio streaming by including the information for the codec configuration of the audio streaming and the information for the QoS configuration of the audio streaming. For example, the label may indicate the information for the codec configuration of the audio streaming and the information for the QoS configuration of the audio streaming by including an identifier indicating the information for the codec configuration of the audio streaming and an identifier indicating the information for the QoS configuration of the audio streaming. For example, the label may indicate the information for the codec configuration of the audio streaming and the information for the QoS configuration of the audio streaming through the identifier indicating the label. However, it is not limited thereto.

For example, the label may be identified based on a signal indicating the idle state of the first external electronic device 201 for the audio streaming received from the first external electronic device 201 through the first communication link, and a signal indicating the idle state of the second external electronic device 202 for the audio streaming received from the second external electronic device 202 through the second communication link, after the first communication link and the second communication link are established. For example, the signal from the first external electronic device 201 and the signal from the second external electronic device 202 may be received before the input is received in operation 403. However, it is not limited thereto.

In operation 407, the processor 120 may transmit a signal indicating the label to the first external electronic device 201 through the first communication link and transmit the signal to the second external electronic device 202 through the second communication link.

For example, the signal may be transmitted to switch, transfer, or change the idle state of the first external electronic device 201 for the audio streaming to the enabling state of the first external electronic device 201 for the audio streaming. For example, the signal transmitted to the first external electronic device 201 may cause (e.g., instruct or inform) the first external electronic device 201 to directly switch the idle state of the first external electronic device 201 for the audio streaming to the enabling state of the first external electronic device 201 for the audio streaming, by bypassing the state of the first external electronic device 201 for the codec configuration and the state of the first external electronic device 201 for the QoS configuration.

For example, the signal may be transmitted to switch, transfer, or change the idle state of the second external electronic device 202 for the audio streaming to the enabling state of the second external electronic device 202 for the audio streaming. For example, the signal transmitted to the second external electronic device 202 may cause (e.g., instruct or inform) the second external electronic device 202 to directly switch the idle state of the second external electronic device 202 for the audio streaming to the enabling state of the second external electronic device 202 for the audio streaming by bypassing the state of the second external electronic device 202 for the codec configuration and the state of the second external electronic device 202 for the QoS configuration.

For example, the format of the signal may vary. For example, the signal may indicate the label by including an identifier indicating the label. For example, the signal may indicate the label by including information on the label. However, it is not limited thereto.

In operation 409, the processor 120 may change a state of electronic device 101 for audio streaming from the idle state to the enabling state based at least partially on a transmission of the signal to the first external electronic device 201 and a transmission of the signal to the second external electronic device 202.

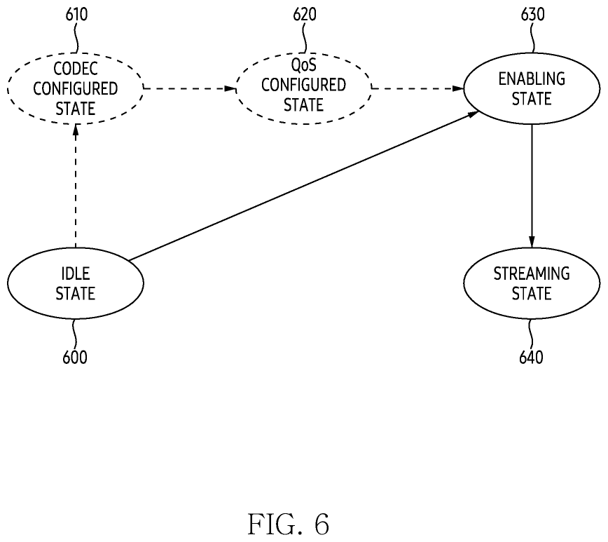

For example, the processor 120 may switch the state from the idle state to the enabling state in response to transmitting the signal to the first external electronic device 201 and the signal to the second external electronic device 202 in operation 407. For example, the processor 120 may switch the state from the idle state to the enabling state in response to receiving a response signal for the signal from the first external electronic device 201 and receiving a response signal for the signal from the second external electronic device 202. For example, the state may be directly switched from the idle state to the enabling state by bypassing the state for the codec configuration and the state for the QoS configuration. Direct switching of the state may be illustrated in FIG. 6.

FIG. 6 illustrates an example of a direct switching from an idle state to an enabling state.

Referring to FIG. 6, each state of the electronic device 101, the first external electronic device 201, and the second external electronic device 202 may include an idle state 600, a codec configured state 610, a QoS configured state 620, an enabling state 630, and a streaming state 640. Although not shown in FIG. 6, each state of the electronic device 101, the first external electronic device 201, and the second external electronic device 202 may further include a release state that may be switched from the idle state 600, the codec configured state 610, the QoS configured state 620, the enabling state 630, and the streaming state 640.

For example, each of the electronic device 101, the first external electronic device 201, and the second external electronic device 202 may be in the idle state 600 before identifying that the audio streaming is initiated.

For example, when the label is not used, each of the electronic device 101, the first external electronic device 201, and the second external electronic device 202 may switch the idle state 600 to the codec configured state 610 through the operations illustrated through operation 301 of FIG. 3, in response to the initiation of the audio streaming. When all of the electronic device 101, the first external electronic device 201, and the second external electronic device 202 are switched to the codec configured state 610, each of the electronic device 101, the first external electronic device 201, and the second external electronic device 202 may switch the codec configured state 610 to the QoS configured state 620 through the operations illustrated in operation 303 of FIG. 3. When all of the electronic device 101, the first external electronic device 201, and the second external electronic device 202 are switched to the QoS configured state 620, each of the electronic device 101, the first external electronic device 201, and the second external electronic device 202 may switch the QoS configured state 620 to the enabling state 630. Each of the electronic device 101, the first external electronic device 201, and the second external electronic device 202 may switch the enabling state 630 to the streaming state 640 based on at least a part of generating a CIG event. As described above, since the switching from the idle state 600 to the enabling state 630 includes the switching from the idle state 600 to the codec configured state 610, the switching from the codec configured state 610 to the QoS configured state 620, and the switching from the QoS configured state 620 to the enable state 630 when the label is not used, the switching the idle state 600 to the enabling state 630 when the label is not used may cause a delay in generating a CIG event including CIS events. Reducing a length of a connection event for each of the switching from the idle state 600 to the codec configured state 610, the switching from the codec configured state 610 to the QoS configured state 620, and the switching from the QoS configured state 620 to the enable state 630 when the label is not used, the switching the idle state 600 to the enabling state 630 may be limited in terms of power consumption. The switching the idle state 600 to the enabling state 630 when the label is not used may cause the delay in generating a CIG event including CIS events.

For example, when the label is used, in response to the initiation of the audio streaming, the electronic device 101 may transmit the signal indicating the label to the first external electronic device 201 and transmit the signal to the second external electronic device 202. For example, based on transmitting the signal to the first external electronic device 201 and transmitting the signal to the second external electronic device 202, the electronic device 101 may directly switch the idle state 600 to the enabling state 630. For example, since the label indicates information for switching to the codec configured state 610, information for switching to the QoS configured state 620, and information for switching to the enabling state 630, the electronic device 101 may switch the idle state 600 to the enabling state 630 by bypassing the switching to the codec configured state 610 and the switching to the QoS configured state 620. For example, the first external electronic device 201 and the second external electronic device 202 may directly switch the idle state 600 to the enabling state 630 based on respectively receiving the signals from the electronic device 101. For example, since the label indicates information for switching to the codec configured state 610, information for switching to the QoS configured state 620, and information for switching to the enabling state 630, the first external electronic device 201 and the second external electronic device 202 may switch the idle state 600 to the enabling state 630 by bypassing the switching to the codec configured state 610 and the switching to the QoS configured state 620. For example, each of the electronic device 101, the first external electronic device 201, and the second external electronic device 202 may switch the enabling state 630 to the streaming state 640 based at least partially on generating a CIG event.

As described above, since the switching from the idle state 600 to the enable state 630 through the label bypasses the switching from the idle state 600 to the codec configured state 610 and the switching from the codec configured state 610 to the QoS configured state 620, the switching the idle state 600 to the enabling state 630 using the label may reduce the time consumed to switch a state before generating a CIG event including CIS events. For example, since the switching from the idle state 600 to the enabling state 630 through the label is not executed by reducing the length of the connection event, the switching from the idle state 600 to the enable state 630 can provide a fast response speed as well as a reduction in power consumption.

FIG. 7 is a flowchart illustrating an exemplary method of identifying a label corresponding to a type of service. This method may be executed by the electronic device 101 in FIG. 1, the electronic device 101 in FIG. 2, the first external electronic device 201 in FIG. 2, the second external electronic device 202 in FIG. 2, the processor 120 in FIG. 1, the processor of the first external electronic device 201 in FIG. 2 and/or the processor of the second external electronic device 202 in FIG. 2.

Operation 701 and operation 703 of FIG. 7 may be included in operation 405 of FIG. 4.

Referring to FIG. 7, in operation 701, the processor 120 may identify a service type of the audio streaming in response to the input received in operation 403. For example, the service type may include a game mode type, a music play type, and/or a conversational type. However, it is not limited thereto. For example, the processor 120 may identify a service type of the audio streaming by identifying a service type indicated by the input. For example, the processor 120 may identify a service type corresponding to the input among a plurality of service types defined in the electronic device 101 as a service type of the audio streaming. However, it is not limited thereto.

In operation 703, the processor 120 may identify a label (e.g., the label identified through operation 405) corresponding to the identified service type among a plurality of labels. For example, each of the plurality of labels may indicate information for codec configuration of audio streaming and information for QoS configuration of each of a plurality of service types defined in the electronic device 101, the first external electronic device 201, and/or the second external electronic device 202. For example, the information on each of the plurality of labels may be stored in the memory of the electronic device 101, the first external electronic device 201, and/or the second external electronic device 202 (e.g., the memory 130 in FIG. 1) before the input is received in operation 403. However, it is not limited thereto.

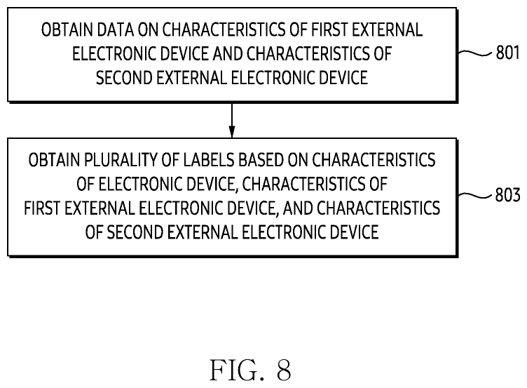

Identifying or obtaining the plurality of labels will be illustrated in FIG. 8.

As described above, the electronic device 101 may directly switch the idle state to the enabling state by identifying the label corresponding to the service type of the audio streaming. For example, the electronic device 101 may reduce the time from the request for the audio streaming to the generation of the CIG event through the above switching.

FIG. 8 is a flowchart illustrating an exemplary method of obtaining a plurality of labels. This method may be executed by the electronic device 101 in FIG. 1, the electronic device 101 in FIG. 2, the first external electronic device 201 in FIG. 2, the second external electronic device 202 in FIG. 2, the processor 120 in FIG. 1, the processor of the first external electronic device 201 in FIG. 2, the processor of the second external electronic device 202 in FIG. 2 and/or another device related to the electronic device 101, the first external electronic device 201, and the second external electronic device 202.

Referring to FIG. 8, in operation 801, the processor 120 may obtain data on characteristics of the first external electronic device 201 and characteristics of the second external electronic device 202. For example, the electronic device 101 may obtain the data on the characteristics of the first external electronic device 201 and the characteristics of the second external electronic device 202 related to services (e.g., published audio capabilities service (PACS) and/or audio stream control service (ASCS)).

For example, the characteristics of the first external electronic device 201 and the characteristics of the second external electronic device 202 may include capability information of the first external electronic device 201 and the second external electronic device 202 for a plurality of service types of audio streaming.

For example, the data may indicate that the first external electronic device 201 operates as a sink device of a front right channel. For example, the data may indicate that the second external electronic device 202 operates as a sink device of a front left channel. For example, the data may indicate that a state of the first external electronic device 201 for the audio streaming is an idle state. For example, the data may indicate that a state of the second external electronic device 202 for the audio streaming is an idle state.

For example, the data may be stored in each of the electronic device 101, the first external electronic device 201, and/or the second external electronic device 202. For example, the data may be obtained through a software application installed within the electronic device 101 to manage the first external electronic device 201 and/or the second external electronic device 202. For example, the data may be obtained from a server for a service provided through the software application. However, it is not limited thereto.

For example, the timing at which the data is obtained may vary. For example, at least a part of the data may be received from the first external electronic device 201 and the second external electronic device 202 in response to establishing the first communication link and the second communication link in operation 401. For example, the at least a part of the data may be obtained after completion of service discovery. However, it is not limited thereto.

In copper 803, the processor 120 may obtain a plurality of labels based on the characteristics of the electronic device 101, the characteristics of the first external electronic device 201, and the characteristics of the second external electronic device 202. For example, each of the plurality of labels may correspond to each of a plurality of service types of audio streaming. For example, each of the plurality of labels may be stored in the memory of the electronic device 101, the first external electronic device 201, and/or the second external electronic device 202 in association with an identifier indicating each of the plurality of labels.

FIG. 8 illustrates an example in which the electronic device 101 obtains the plurality of labels based on the characteristics of the electronic device 101, the characteristics of the first external electronic device 201, and the characteristics of the second external electronic device 202, but it is for convenience of description. For example, the plurality of labels may be obtained through a server related to the electronic device 101. For example, the server may respectively obtain characteristics of the electronic device 101 and characteristics of the first external electronic device 201, and characteristics of the second external electronic device 202 from the electronic device 101, the first external electronic device 201, and the second external electronic device 202, and obtain the plurality of labels based on the characteristics of the electronic device 101, the characteristics of the first external electronic device 201, and the characteristics of the second external electronic device 202. However, it is not limited thereto. For example, the electronic device 101 may obtain data on each of the characteristics of the first external electronic device 201 and the characteristics of the second external electronic device 202 from each of the first external electronic device 201 and the second external electronic device 202. The electronic device 101 may provide data on the characteristics of the electronic device 101, the characteristics of the first external electronic device 201, and the characteristics of the second external electronic device 202 to the server, based on obtaining the data.

For example, the server may provide obtained information on the plurality of labels to the electronic device 101, the first external electronic device 201, and/or the second external electronic device 202. However, it is not limited thereto. For example, when the information is provided from the server to the electronic device 101 of the electronic device 101, the first external electronic device 201, and the second external electronic device 202, the electronic device 101 may provide the information to each of the first external electronic device 201 and the second external electronic device 202.

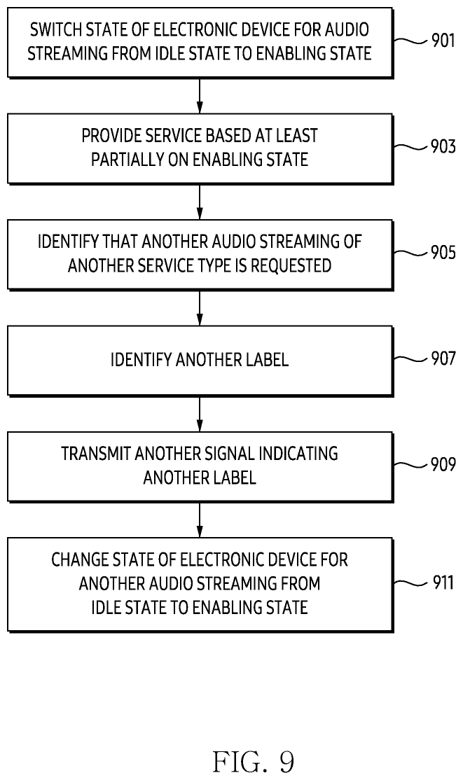

FIG. 9 illustrates an exemplary method of transmitting a signal indicating a label for another audio streaming in response to a request from another audio streaming identified while the service of audio streaming is provided. This method may be executed by the electronic device 101 in FIG. 1, the electronic device 101 in FIG. 2, the first external electronic device 201 in FIG. 2, the second external electronic device 202 in FIG. 2, the processor 120 in FIG. 1, the processor of the first external electronic device 201 in FIG. 2 and/or the processor of the second external electronic device 202 in FIG. 2.

Referring to FIG. 9, in operation 901, the processor 120 may switch a state of the electronic device 101 for the audio streaming from an idle state to an enabling state. For example, the switching may be executed based at least partially on the signal transmitted in operation 407 of FIG. 4. For example, operation 901 may correspond to operation 409 of FIG. 4.

In operation 903, the processor 120 may provide a service of the audio streaming with the first external electronic device 201 and the second external electronic device 202 based at least partially on the enabling state. For example, in the streaming state switched from the enabling state, the processor 120 may provide the service by executing the audio streaming using CIS events with each of the first external electronic device 201 and the second external electronic device 202 switched to the streaming state.

In operation 905, the processor 120 may identify that another audio streaming of another service type is requested, which is distinguished from the service type of audio streaming, while providing the service of the audio streaming with the first external electronic device 201 and the second external electronic device 202 based at least partially on the enabling state.

For example, a request for the other audio streaming may be variously triggered. For example, the other audio streaming may be requested based on a received call from another electronic device. For example, the other audio streaming may be requested based on the execution of another software application distinct from a software application related to the audio streaming. However, it is not limited thereto.

In operation 907, in response to the identification in operation 905, the processor 120 may identify another label indicating information for codec configuration of the other audio streaming and information for QoS configuration of the other audio streaming. For example, the other label may be distinguished from the label used for the service provided in operation 903. For example, the other label may be identified among the plurality of labels illustrated in FIGS. 7 and/or 8. For example, the other label may be a label corresponding to the other service type of the other audio streaming among the plurality of labels.

In operation 909, the processor 120 may transmit another signal (e.g., a signal distinct from the signal transmitted in operation 407) to the first external electronic device 201 through the first communication link, and transmit the other signal to the second external electronic device 202 through the second communication link.

For example, the other signal may be transmitted to switch, transfer, or change the idle state of the first external electronic device 201 for the other audio streaming to the enabling state of the first external electronic device 201 for the other audio streaming. For example, by bypassing a state for the codec configuration of the first external electronic device 201 for the other audio streaming and a state for the QoS configuration of the first external electronic device 201 for the other audio streaming, the other signal transmitted to the first external electronic device 201 may cause (e.g., instruct or inform) the first external electronic device 201 to directly switch the idle state of the first external electronic device 201 to the enabling state of the first external electronic device 201 for the other audio streaming.

For example, the other signal may be transmitted to switch, transfer, or change the idle state of the second external electronic device 202 for the other audio streaming to the enabling state of the second external electronic device 202 for the other audio streaming. For example, by bypassing a state for the codec configuration of the second external electronic device 202 for the other audio streaming and a state for the QoS configuration of the second external electronic device 202 for the other audio streaming, the other signal transmitted to the second external electronic device 202 may cause (e.g., instruct or inform) the second external electronic device 202 to directly switch the idle state of the second external electronic device 202 to the enabling state of the second external electronic device 202 for the other audio streaming.

For example, a format of the other signal may vary. For example, the other signal may indicate the other label by including an identifier including the other label. For example, the other signal may indicate the other label by including information on the other label. However, it is not limited thereto.

In operation 911, the processor 120 may change a state of the electronic device 101 for the other audio streaming from the idle state to the enabling state, based on the other signal transmitted to the first external electronic device 201 and to the second external electronic device 202.

For example, in operation 909, in response to transmitting the other signal to the first external electronic device 201 and transmitting the other signal to the second external electronic device 202, the processor 120 may switch the state of the electronic device 101 for the other audio streaming from the idle state to the enabling state. For example, in response to receiving a response signal to the other signal from the first external electronic device 201 and receiving a response signal to the other signal from the second external electronic device 202, the processor 120 may switch the state for the other audio streaming from the idle state to the enabling state. For example, the state for the other audio streaming can be directly switched from the idle state to the enabling state by bypassing the state for the codec configuration and the state for the QoS configuration.

As described above, when the request for the second audio streaming is obtained while the service of the first audio streaming is provided based on the first label, the electronic device 101 may identify the second label corresponding to the service type of the second audio streaming. Based on transmitting a signal indicating the second label to the first external electronic device 201 and the second external electronic device 202, the electronic device 101 may directly switch the state for the second audio streaming from the idle state to the enabling state. Based on the switching, the electronic device 101 may not only execute the second audio streaming at a fast response speed but also reduce power consumption according to execution of the second audio streaming.

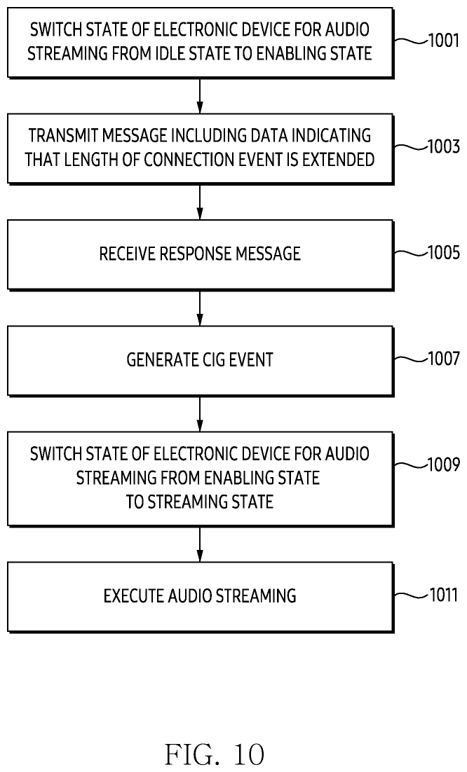

FIG. 10 is a flowchart illustrating an exemplary method of transmitting a message for generating a CIG event including CIS events. This method may be executed by the electronic device 101 in FIG. 1, the electronic device 101 in FIG. 2, the first external electronic device 201 in FIG. 2, the second external electronic device 202 in FIG. 2, the processor 120 in FIG. 1, the processor of the first external electronic device 201 in FIG. 2 and/or the processor of the second external electronic device 202 in FIG. 2.

Referring to FIG. 10, in operation 1001, the processor 120 may switch a state of the electronic device 101 for the audio streaming from the idle state to the enabling state. For example, the switching may be executed based at least partially on the signal transmitted in operation 407 of FIG. 4. For example, operation 1001 may correspond to operation 409 of FIG. 4.

In operation 1003, in response to the switching to the enabling state, the processor 120 may transmit a message indicating a request for a first CIS event to the first external electronic device 201 through the first communication link and a message indicating a request for a second CIS event to the second external electronic device 202 through the second communication link. For example, the first CIS event and the second CIS event may be included in the CIG event. For example, the first CIS event may be a CIS event for the first external electronic device 201, and the second CIS event may be a CIS event for the second external electronic device 202.

For example, the message transmitted to the first external electronic device 201 may include data indicating that a length of a connection event with the first external electronic device 201 used to transmit the message is extended. For example, the message may be a link layer (LL) CIS request (REQ). For example, the message may include a more data (MD) field in the header. For example, the data in the message may indicate that the length of the connection event with the first external electronic device 201 is extended through the MD field.

For example, the processor 120 may transmit the message indicating that the length of the connection event is extended to reduce the time until a generation of the CIG event (or the first CIS event) is completed. For example, the message may indicate that the length of the connection event is extended to complete signaling to generate the CIG event (or the first CIS event) in a single connection event. For example, the message may indicate that the length of the connection event is extended to execute a reception of a response message (e.g., acknowledgement message for LL CIS response (RES) and/or LL CIS indication (IND) transmitted from the electronic device 101) to be illustrated through operation 1005 and a transmission of the message within a single connection event.

For example, the message transmitted to the second external electronic device 202 may include data indicating that the length of a connection event with the second external electronic device 202 used to transmit the message is extended. For example, the message may be an LL CIS REQ. For example, the message may include a more data (MD) field in the header. For example, the data in the message may indicate that the length of the connection event with the second external electronic device 202 is extended through the MD field.

For example, the processor 120 may transmit the message indicating that the length of the connection event is extended to reduce the time until the generation of the CIG event (or the second CIS event) is completed. For example, the message may indicate that the length of the connection event is extended to complete signaling to generate the CIG event (or the second CIS event) in a single connection event. For example, the message may indicate that the length of the connection event is extended to execute a reception of a response message (e.g., acknowledgement message for LL CIS RES and/or LL CIS IND transmitted from the electronic device 101) to be illustrated through operation 1005 and a transmission of the message within a single connection event.

In operation 1005, the processor 120 may receive the response message for the message from the first external electronic device 201 through the first communication link and receive the response message for the message from the second external electronic device 202 through the second communication link. For example, the first external electronic device 201 and the second external electronic device 202 may switch the enabling state to a streaming state in response to transmission of the response message, reception of another message (e.g., LL CIS IND) transmitted from the electronic device 101 in response to the response message, and transmission of an acknowledgement message for the other message.

In operation 1007, based on receiving the response message from the first external electronic device 201 through the first communication link and receiving the response message from the second external electronic device 202 through the second communication link, the processor 120 may generate the CIG event including the first CIS event and the second CIS event.

In operation 1009, in response to generating the CIG event, the processor 120 may switch a state of the electronic device 101 for the audio streaming from the enabling state to the streaming state. For example, the processor 120 may switch the state to the streaming state to provide a service of the audio streaming using the CIG event.

In operation 1011, the processor 120 may perform the audio streaming with the first external electronic device 201 and the second external electronic device 202. For example, the processor 120 may execute the audio streaming with the first external electronic device 201 switched to the streaming state using the first CIS event in the CIG event, and execute the audio streaming with the second external electronic device 202 switched to the streaming state using the second CIS event in the CIG event.

For example, the audio streaming may include each of the first external electronic device 201 and the second external electronic device 202 outputting the audio, based on data on audio transmitted from the electronic device 101 to each of the first external electronic device 201 and the second external electronic device 202 through the CIG event. For example, the audio streaming may include the electronic device 101 outputting the audio, based on data on audio obtained by each of the first external electronic device 201 and the second external electronic device 202, in response to a request from the electronic device 101 to each of the first external electronic device 201 and the second external electronic device 202. However, it is not limited thereto.

As described above, the electronic device 101 may extend the length of the connection event through the message transmitted in operation 1003. Based on the extension, the electronic device 101 may complete signaling for generating the first CIS event in a single connection event and may complete signaling for generating the second CIS event in a single connection event. For example, since the generation of the first CIS event and the generation of the second CIS event are completed in the single connection event, the electronic device 101 may reduce the time consumed to generate the CIG event. For example, the electronic device 101 may provide a service of audio streaming at a fast response speed through the reduction in time.

The above descriptions describe operations for providing audio services through the electronic devices 101 operating as central devices and two external electronic devices (e.g., the first external electronic device 201 and the second external electronic device 202) operating respectively as peripheral devices. The operations may be used to provide audio services through a central device and a single external electronic device (or a single peripheral device).

For example, the processor 120 of the electronic device 101 operating as a central device may establish a communication link with an external electronic device operating as a peripheral device. For example, the processor 120 may receive an input indicating that the audio service is initiated through the communication link. For example, in response to the input, the processor 120 may identify a label indicating information for codec configuration of audio streaming of the audio service and information for QoS configuration of the audio streaming. For example, the processor 120 may transmit a signal indicating the label to the external electronic device through the communication link. For example, the processor 120 may switch a state of the electronic device 101 for the audio streaming from the idle state to the enabling state based on the transmission of the signal.

For example, the state may be directly switched from the idle state to the enabling state by bypassing the state for the codec configuration and the state for the QoS configuration based on the transmission of the signal to the external electronic device. For example, the signal may be used to bypass the state of the external electronic device for the codec configuration and the state of the external electronic device for the QoS configuration. For example, the signal may be used to directly switch the state of the external electronic device for the audio streaming from the idle state to the enabling state.

For example, the information for the codec configuration indicated by the signal may include data indicating a codec identifier of the audio streaming, data indicating a target latency of the audio streaming, and data indicating a target transmission speed for the target latency of the audio streaming. For example, the information for the QoS configuration indicated by the signal may include data indicating max transport latency of the audio streaming, data indicating the transmission speed for the max transport latency of the audio streaming, data indicating a period for the audio streaming, and data indicating whether framing a data packet for the audio streaming.

For example, the processor 120 may generate a CIS event for the external electronic device based at least partially on the switching of the state. For example, the processor 120 may transmit a message indicating a request for the CIS event to the external electronic device in response to the switching. For example, the message may include data indicating that the length of the connection event with the external electronic device is extended (e.g., data in the MD field in header of the message). For example, the processor 120 may receive a response message for the message from the external electronic device. For example, the processor 120 may generate the CIS event based at least partially on the response message.

For example, the processor 120 may switch the enabling state to a streaming state based on the generation of the CIS event. For example, the processor 120 may execute audio streaming with the external electronic device switched to the streaming state using the CIS event.

As described above, according to an embodiment, an electronic device 101 operating as a central device in a wireless environment may include a communication circuit 192 for Bluetooth low energy (BLE). According to an embodiment, the electronic device 101 may include a processor 120 operably coupled with the communication circuit 192. According to an embodiment, the processor 120 may be configured to establish, through the communication circuit 192, a first communication link with a first external electronic device 201 operating as a first peripheral device and a second communication link with a second external electronic device 202 operating as a second peripheral device. According to an embodiment, the processor 120 may be configured to identify an input indicating to initiate audio streaming through the first communication link and the second communication link. According to an embodiment, the processor 120 may be configured to obtain a label indicating information for codec configuration of the audio streaming and information for quality of server (QoS) configuration of the audio streaming, in response to the input. According to an embodiment, the processor 120 may be configured to transmit a signal indicating the obtained label through the first communication link to the first external electronic device 201 and transmit the signal through the second communication link to the second external electronic device 202. According to an embodiment, the processor 120 may be configured to change a state of the electronic device 101 for the audio streaming from an idle state 600 to an enabling state 630, based on the transmission of the signal to the first external electronic device 201 and the transmission of the signal to the second external electronic device 202.

According to an embodiment, the state may be directly changed from the idle state 600 to the enabling state 630 by bypassing a state for the codec configuration and a state for the QoS configuration, based on the transmission of the signal to the first external electronic device 201 and the transmission of the signal to the second external electronic device 202.

According to an embodiment, the signal transmitted to the first external electronic device 201 may cause the first external electronic device 201 to directly change an idle state 600 of the first external electronic device 201 for the audio streaming to an enabling state 630 of the first external electronic device 201 for the audio streaming by omitting a state for the codec configuration of the first external electronic device 201 and a state for the QoS configuration of the first external electronic device 201.

According to an embodiment, the signal transmitted to the second external electronic device 202 may cause the second external electronic device 202 to directly change an idle state 600 of the second external electronic device 202 for the audio streaming to an enabling state 630 of the second external electronic device 202 for the audio streaming by omitting a state for the codec configuration of the second external electronic device 202 and a state for the QoS configuration of the second external electronic device 202.

According to an embodiment, the processor 120 may be further configured to generate connected isochronous group (CIG) event that includes a first connected isochronous stream (CIS) event for the first external electronic device 201 and a second CIS event for the second external electronic device 202, based on the switching to the enabling state 630.

According to an embodiment, the processor 120 may be configured to, in response to the switching to the enabling state 630, transmit a message indicating a request of the first CIS event through the first communication link to the first external electronic device 201 and transmit a message indicating a request of the second CIS event through the second communication link to the second external electronic device 202. According to an embodiment, the processor 120 may be configured to establish the CIG event, based on receiving a response message regarding the message through the first communication link from the first external electronic device 201 and receiving a response message regarding the message through the second communication link from the second external electronic device 202. According to an embodiment, the message transmitted to the first external electronic device 201 may include data indicating to extend length of a connection event with the first external electronic device 201 used for transmitting the message. According to an embodiment, the message transmitted to the second external electronic device 202 may include data indicating to extend length of a connection event with the second external electronic device 202 used for transmitting the message.

According to an embodiment, the data in the message transmitted to the first external electronic device 201 may indicate to extend the length of the connection event with the first external electronic device 201 through a more data (MD) field in a header of the message transmitted to the first external electronic device 201. According to an embodiment, the data in the message transmitted to the second external electronic device 202 may indicate to extend the length of the connection event with the second external electronic device 202 through a MD field in a header of the message transmitted to the second external electronic device 202.

According to an embodiment, the processor 120 may be configured to switch the state of the electronic device 101 from the enabling state 630 to a streaming state, in response to generating the CIG event. According to an embodiment, the processor 120 may be configured to perform the audio streaming with the first external electronic device 201 switched as a streaming state, by using the first CIS event in the CIG event. According to an embodiment, the processor 120 may be configured to perform the audio streaming with the second external electronic device 202 switched as a streaming state, by using the second CICS event in the CIG event.

According to an embodiment, the information for the codec configuration may include data indicating a code identifier of the audio streaming, data indicating target latency of the audio streaming, and data indicating target transmission speed for the target latency of the audio streaming.

According to an embodiment, the information for the QoS configuration may include data indicating max transport latency of the audio streaming, data indicating transmission speed for the max transport latency of the audio streaming, data indicating period for the audio streaming, and data indicating whether framing a data packet for the audio streaming.

According to an embodiment, the processor 120 may be configured to obtain the label corresponding to a service type of the audio streaming among multiple labels, in response to the input. According to an embodiment, each of the multiple labels may indicate information for codec configuration and QoS configuration of audio streaming of each of a plurality of service types.

According to an embodiment, each of the multiple labels may be identified based at least in part on characteristics of the electronic device 101 associated with audio streaming of each of the plurality of service types, characteristics of the first external electronic device 201 associated with audio streaming of each of the plurality of service types, and characteristics of the second external electronic device 202 associated with audio streaming of each of the plurality of service types.

According to an embodiment, the processor 120 may be further configured to receive a signal indicating an idle state 600 of the first external electronic device 201 for the audio streaming through the first communication link from the first external electronic device 201 and receive a signal indicating an idle state 600 of the second external electronic device 202 for the audio streaming through the second communication link from the second external electronic device 202, before the input is received.

According to an embodiment, the signal may indicate to directly change the idle state 600 to the enabling state 630.

According to an embodiment, the signal may include an identifier indicating the label.

According to an embodiment, the processor 120 may be configured to identify that another audio streaming of another service type distinct from a service type of the audio streaming is requested, while providing a service of the audio streaming with the first external electronic device 201 and the second external electronic device 202 based at least in part on the enabling state 630. According to an embodiment, the processor 120 may be configured to identify another label that indicates information for codec configuration of the other audio streaming and information for QoS configuration of the other audio streaming, in response to identifying that the other audio streaming is requested. According to an embodiment, the processor 120 may be configured to transmit another signal indicating the other label through the first communication link to the first external electronic device 201 and transmit the other signal through the second communication link to the second external electronic device 202. According to an embodiment, the processor 120 may be configured to switch a state of the electronic device 101 for the other audio streaming from an idle state 600 to an enabling state 630, based on the transmission of the other signal to the first external electronic device 201 and the transmission of the other signal to the second external electronic device 202.

A method executed in an electronic device 101 operating as a central device in a wireless environment may include establishing, through the communication circuit 192, a first communication link with a first external electronic device 201 operating as a first peripheral device and a second communication link with a second external electronic device 202 operating as a second peripheral device. According to an embodiment, the method may include receiving an input indicating to initiate audio streaming through the first communication link and the second communication link. According to an embodiment, the method may include identifying a label indicating information for codec configuration of the audio streaming and information for quality of service (QoS) configuration of the audio streaming, in response to the input. According to an embodiment, the method may include transmitting a signal indicating the identified label through the first communication link to the first external electronic device 201 and transmitting the signal through the second communication link to the second external electronic device 202. According to an embodiment, the method may include switching a state of the electronic device 101 for the audio streaming from an idle state 600 to an enabling state 630, based on the transmission of the signal to the first external electronic device 201 and the transmission of the signal to the second external electronic device 202.

According to an embodiment, the state may be directly switched from the idle state 600 to the enabling state 630 by bypassing a state for the codec configuration and a state for the QoS configuration, based on the transmission of the signal to the first external electronic device 201 and the transmission of the signal to the second external electronic device 202.

According to an embodiment, the signal transmitted to the first external electronic device 201 may cause the first external electronic device 201 to directly switch an idle state 600 of the first external electronic device 201 for the audio streaming to an enabling state 630 of the first external electronic device 201 for the audio streaming by bypassing a state for the codec configuration of the first external electronic device 201 and a state for the QoS configuration of the first external electronic device 201. According to an embodiment, the signal transmitted to the second external electronic device 202 may cause the second external electronic device 202 to directly switch an idle state 600 of the second external electronic device 202 for the audio streaming to an enabling state 630 of the second external electronic device 202 for the audio streaming by bypassing a state for the codec configuration of the second external electronic device 202 and a state for the QoS configuration of the second external electronic device 202.

According to an embodiment, the method may include generating connected isochronous group, CIG, event that includes a first connected isochronous stream, CIS, event for the first external electronic device 201 and a second CIS event for the second external electronic device 202, based on the switching to the enabling state 630.

According to an embodiment, the generating the CIG event may include, in response to the switching to the enabling state 630, transmitting a message indicating a request of the first CIS event through the first communication link to the first external electronic device 201 and transmitting a message indicating a request of the second CIS event through the second communication link to the second external electronic device 202. According to an embodiment, the generating the CIG event may include generating the CIG event, based on receiving a response message regarding the message through the first communication link from the first external electronic device 201 and receiving a response message regarding the message through the second communication link from the second external electronic device 202.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device operating as a central device in a wireless environment, the electronic device comprising:
a communication circuit for Bluetooth low energy (BLE); and
a processor, operably coupled with the communication circuit, configured to:
establish, through the communication circuit, a first communication link with a first external electronic device operating as a first peripheral device and a second communication link with a second external electronic device operating as a second peripheral device;
receive an input indicating to initiate audio streaming through the first communication link and the second communication link;
identify a label indicating information for codec configuration of the audio streaming and information for quality of server (QoS) configuration of the audio streaming, in response to the input;
transmit a signal indicating the identified label through the first communication link to the first external electronic device and transmit the signal through the second communication link to the second external electronic device; and
switch a state of the electronic device for the audio streaming from an idle state to an enabling state, based on the transmission of the signal to the first external electronic device and the transmission of the signal to the second external electronic device.

2. The electronic device of claim 1, wherein the state is directly switched from the idle state to the second state by bypassing a state for the codec configuration and a state for the QoS configuration, based on the transmission of the signal to the first external electronic device and the transmission of the signal to the second external electronic device.

3. The electronic device of claim 2, wherein the signal transmitted to the first external electronic device causes the first external electronic device to directly switch an idle state of the first external electronic device for the audio streaming to an enabling state of the first external electronic device for the audio streaming by bypassing a state for the codec configuration of the first external electronic device and a state for the QoS configuration of the first external electronic device, and
wherein the signal transmitted to the second external electronic device causes the second external electronic device to directly switch an idle state of the second external electronic device for the audio streaming to an second state of the second external electronic device for the audio streaming by bypassing a state for the codec configuration of the second external electronic device and a state for the QoS configuration of the second external electronic device.

4. The electronic device of claim 1, wherein the processor is further configured to generate connected isochronous group, CIG, event that includes a first connected isochronous stream, CIS, event for the first external electronic device and a second CIS event for the second external electronic device, based on the switching to the second state.

5. The electronic device of claim 4, wherein the processor is configured to:
in response to the switching to the second state, transmit a message indicating a request of the first CIS event through the first communication link to the first external electronic device and transmit a message indicating a request of the second CIS event through the second communication link to the second external electronic device; and
generate the CIG event, based on receiving a response message regarding the message through the first communication link from the first external electronic device and receiving a response message regarding the message through the second communication link from the second external electronic device,
wherein the message transmitted to the first external electronic device includes data indicating to extend length of a connection event with the first external electronic device used for transmitting the message, and
wherein the message transmitted to the second external electronic device includes data indicating to extend length of a connection event with the second external electronic device used for transmitting the message.

6. The electronic device of claim 5, wherein the data in the message transmitted to the first external electronic device indicates to extend the length of the connection event with the first external electronic device through a more data, MD, field in a header of the message transmitted to the first external electronic device, and
wherein the data in the message transmitted to the second external electronic device indicates to extend the length of the connection event with the second external electronic device through a MD field in a header of the message transmitted to the second external electronic device.

7. The electronic device of claim 4, wherein the processor is further configured to:
switch the state of the electronic device from the second state to a streaming state, in response to generating the CIG event;
execute the audio streaming with the first external electronic device switched as a streaming state, by using the first CIS event in the CIG event; and
execute the audio streaming with the second external electronic device switched as a streaming state, by using the second CICS event in the CIG event.

8. The electronic device of claim 1, wherein the information for the codec configuration includes data indicating a code identifier of the audio streaming, data indicating target latency of the audio streaming, and data indicating target transmission speed for the target latency of the audio streaming.

9. The electronic device of claim 1, wherein the information for the QoS configuration includes data indicating max transport latency of the audio streaming, data indicating transmission speed for the max transport latency of the audio streaming, data indicating period for the audio streaming, and data indicating whether framing a data packet for the audio streaming.

10. The electronic device of claim 1, wherein the processor is configured to identify the label corresponding to a service type of the audio streaming among multiple labels, in response to the input, and
wherein each of the multiple labels indicates information for codec configuration and QoS configuration of audio streaming of each of a plurality of service types.

11. The electronic device of claim 10, wherein each of the multiple labels is identified based at least in part on characteristics of the electronic device associated with audio streaming of each of the plurality of service types, characteristics of the first external electronic device associated with audio streaming of each of the plurality of service types, and characteristics of the second external electronic device associated with audio streaming of each of the plurality of service types.

12. The electronic device of claim 1, wherein the processor is further configured to receive a signal indicating an idle state of the first external electronic device for the audio streaming through the first communication link from the first external electronic device and receive a signal indicating an idle state of the second external electronic device for the audio streaming through the second communication link from the second external electronic device, before the input is received.

13. The electronic device of claim 1, wherein the signal indicates to directly switch the idle state to the second state.

14. The electronic device of claim 1, wherein the signal includes an identifier indicating the label.

15. The electronic device of claim 1, wherein the processor is configured to:
identify that another audio streaming of another service type distinct from a service type of the audio streaming is requested, while providing a service of the audio streaming with the first external electronic device and the second external electronic device based at least in part on the enabling state;
identify another label that indicates information for codec configuration of the other audio streaming and information for QoS configuration of the other audio streaming, in response to identifying that the other audio streaming is requested;
transmit another signal indicating the other label through the first communication link to the first external electronic device and transmit the other signal through the second communication link to the second external electronic device; and
switch a state of the electronic device for the other audio streaming from an idle state to an enabling state, based on the transmission of the other signal to the first external electronic device and the transmission of the other signal to the second external electronic device.

16. A method executed in an electronic device operating as a central device in a wireless environment, the method comprising:
establishing, through a communication circuit of the electronic device, a first communication link with a first external electronic device operating as a first peripheral device and a second communication link with a second external electronic device operating as a second peripheral device;
receiving an input indicating to initiate audio streaming through the first communication link and the second communication link;
identifying a label indicating information for codec configuration of the audio streaming and information for quality of service (QoS) configuration of the audio streaming, in response to the input;
transmitting a signal indicating the identified label through the first communication link to the first external electronic device and transmitting the signal through the second communication link to the second external electronic device; and
switching a state of the electronic device for the audio streaming from an idle state to an second state, based on the transmission of the signal to the first external electronic device and the transmission of the signal to the second external electronic device.

17. The method of claim 16, wherein the state is directly switched from the idle state to the second state by bypassing a state for the codec configuration and a state for the QoS configuration, based on the transmission of the signal to the first external electronic device and the transmission of the signal to the second external electronic device.

18. The method of claim 17, wherein the signal transmitted to the first external electronic device causes the first external electronic device to directly switch an idle state of the first external electronic device for the audio streaming to an second state of the first external electronic device for the audio streaming by bypassing a state for the codec configuration of the first external electronic device and a state for the QoS configuration of the first external electronic device, and
wherein the signal transmitted to the second external electronic device causes the second external electronic device to directly switch an idle state of the second external electronic device for the audio streaming to an second state of the second external electronic device for the audio streaming by bypassing a state for the codec configuration of the second external electronic device and a state for the QoS configuration of the second external electronic device.

19. The method of claim 16, further comprising:
generating connected isochronous group, CIG, event that includes a first connected isochronous stream, CIS, event for the first external electronic device and a second CIS event for the second external electronic device, based on the switching to the second state.

20. The method of claim 19, wherein generating the CIG event comprises:
in response to the switching to the second state, transmitting a message indicating a request of the first CIS event through the first communication link to the first external electronic device and transmitting a message indicating a request of the second CIS event through the second communication link to the second external electronic device; and
generating the CIG event, based on receiving a response message regarding the message through the first communication link from the first external electronic device and receiving a response message regarding the message through the second communication link from the second external electronic device.
